(19) United States
(12) Patent Application Publication
(10) Pub. No.: US 2023/0080990 A1
(43) Pub. Date: Mar. 16, 2023

(54) EYEWEAR

(71) Applicant: Shimano Inc., Osaka (JP)

(72) Inventors: Yoshinori IRIE, Osaka (JP); Daichi MATSUMOTO, Osaka (JP)

(21) Appl. No.: 17/876,800

(22) Filed: Jul. 29, 2022

(30) Foreign Application Priority Data
Sep. 14, 2021 (JP) 2021-149680

(51) Int. Cl. G02C 1/00; G02C 1/02; G02C 11/04

(52) U.S. Cl. CPC G02C 1/10; G02C 1/02; G02C 11/04

(57) ABSTRACT

An eyewear basically includes a front frame, a pair of temples, a lens assembly and a pair of engagement members. The front frame has a pair of connecting parts. Each of the temples has one end connected to the front frame so as to be openable and closeable relative to the front frame. The lens assembly has a light transmission part for transmitting light, and a pair of connected parts are respectively connected to the connecting parts at a time of attachment to the front frame, so that the lens assembly can be detachably attached to the front frame. The engagement members are respectively provided to the temples, and are configured to move toward and away from the front frame in association with opening and closing motions of the temples, so that the engagement members are engageable with the lens assembly.

### CROSS-REFERENCE TO RELATED APPLICATION

This application claims priority to Japanese Patent Application No. 2021-149680, filed on Sep. 14, 2021. The entire disclosure of Japanese Patent Application No. 2021-149680 is hereby incorporated herein by reference.

### BACKGROUND

### Technical Field

The present disclosure generally relates to an eyewear such as sunglasses or eyeglasses.

### Background Information

There is an eyewear configured to enable a lens assembly to be detachably attached to a frame (e.g., Japanese Laid-Open Patent Publication No. 2003-315751). The eyewear disclosed in Japanese Laid-Open Patent Publication No. 2003-315751 has levers respectively disposed on both right and left ends of a front frame to be moved to open and close relative to the front frame. Magnets are disposed respectively on the front frame and the lever. The magnets are disposed to attract to each other.

The lens assembly is positioned so as to be sandwiched between the front frame and the lever in closed state so that the magnets respectively disposed on the front frame and the lever attract to each other with the lens assembly sandwiched therebetween. Thereby, the lens assembly is held between the front frame and the lever.

The above configuration however has some disadvantages to be improved. A first disadvantage to be raised is that holding the lens assembly only by the magnetic force is likely to cause the lens assembly to fall from the front frame when an impact is applied to the eyewear. A second disadvantage to be raised is that when the lens assembly is attached to the front frame, the levers provided at both ends of the front frame must be closed, and when the lens assembly is detached from the front frame, the levers must be opened, which causes troublesome lens assembly attaching and detaching works.

### SUMMARY

In view of the above, one object of the present disclosure is to provide an eyewear that makes it possible to securely prevent falling of the lens assembly when it is worn by a user, and to achieve easy attachment and detachment of the lens assembly when it is not worn.

The following presents a simplified summary of the present disclosure in order to provide a basic understanding of some aspects of the eyewear of the present disclosure. This summary is not an extensive overview of the eyewear of the present disclosure. It is intended to neither identify key or critical elements of the eyewear of the present disclosure nor delineate the scope of the invention. Its sole purpose is to present some concepts of the eyewear of the present disclosure in a simplified form as a prelude to the more detailed description that is presented later.

According to the present disclosure, an eyewear is provided that basically includes a front frame, a pair of temples, a lens assembly and a pair of engagement members. The front frame has a pair of connecting parts The temples are connected to the front frame to be openable and closeable relative to the front frame. The lens assembly has a light transmission part for transmitting light, and a pair of connected parts to be respectively connected to the connecting parts at the time of attachment to the front frame, so that the lens assembly can be detachably attached to the front frame. The engagement members are respectively provided to the temples, and are configured to move toward and away from the front frame in association with opening and closing motions of the temples, so that the engagement members are engageable with the lens assembly.

According to the above configuration, the engagement of the temples with the lens assembly can be made in addition to the connection of the connecting parts of the front frame with the connected parts of the lens assembly. With this configuration, it is possible to make it hard for the lens assembly which is held by both the front frame and the temples to fall from the front frame. Further, since each of the engagement members moves in association with the opening and closing motions of each corresponding one of the temples, in the case where the temples are opened for, for example, wearing, the engagement members can be accordingly brought into engagement with the lens assembly. This eliminates the necessity to perform the operation exclusively for the engagement of the temples with the lens assembly.

Further, each of the engagement members can be disposed at a front frame side end of each corresponding one of the temples.

According to the above configuration, a part of each of the temples can be served as each corresponding engagement member so that the engagement member which moves toward and away from the front frame can be formed in a simple manner.

Further, each of the engagement members is engageable with the lens assembly when each corresponding one of the temples is in an open state.

According to the above configuration, the engagement with the lens assembly can be made by the opening of each corresponding one of the temples, and therefore the engagement member functions as expected in the wearing by the user so that it is possible to securely reduce or eliminate the risk of falling of the lens assembly.

Each of the connected parts and each corresponding one of the engagement members can at least partly overlap with each other when the lens assembly is seen in the direction toward the front side of the lens assembly, in the state where the lens assembly is attached to the front frame and each of the engagement members engages with the lens assembly.

According to the above configuration, with the positional relationship where each of the connected parts and each corresponding one of the engagement members partly overlap with each other when seen in the direction toward the front side, the connection between each of the connecting parts and each corresponding one of the connected parts is made at the same position as the position at which the engagement of each corresponding one of the engagement members with the lens assembly is made. Thus, the engagement members can assist the connection between the connecting parts and the connected parts.

The lens assembly can be configured such that it is located on the front side of the front frame, and each of the engagement members presses each corresponding one of the connected parts toward the front frame in the state where the engagement members engage with the lens assembly.

According to the above configuration, the connection can be more securely achieved by the pressing in addition to the engagement.

It is also configured such that a magnet is provided to disposed at any one of each one of the connecting parts and each corresponding one of the connected parts, while a magnetic substance to which the magnet is attracted is provided to disposed at the remaining one of the connecting part and the connected part.

According to the above configuration, the combination of the magnet and the magnetic substance causes the connection by the magnetic force. Thus, it is possible to securely prevent falling of the light transmission part by the engagement members while enabling easy attachment and detachment between the light transmission part and the frame.

The lens assembly can be configured to have a right eye part and a left eye part that are integrally formed with each other.

According to the above configuration, the right and left parts can be attached and detached simultaneously and therefore easy attachment and detachment of the lens assembly can be achieved.

According to the present disclosure, it is possible to make it hard for the lens assembly to fall from the front frame, and eliminate the necessity to take a special operation for the engagement. Therefore, it is possible to provide an eyewear that makes it possible to securely prevent falling of the lens assembly when the user wears the eyewear, and achieve easy attachment and detachment of the lens assembly when the eyewear is not worn.

### BRIEF DESCRIPTION OF THE DRAWINGS

The foregoing and other features of the present disclosure will become apparent from the following description and drawings of an illustrative embodiment of the present disclosure in which:

FIG. 1 is a front perspective view of an eyewear (sunglasses) according to one embodiment of the present disclosure.

FIG. 2 is a front perspective view of a frame part of the eyewear illustrated in FIG. 1.

FIG. 3 is a front perspective view of a lens assembly of the eyewear illustrated in FIG. 1.

FIG. 4 is an enlarged perspective view of a connection portion of the eyewear between a front frame and a temple of the eyewear illustrated in FIG. 1 as seen from the user's face side toward the front side.

FIG. 5 is an enlarged bottom view of the connection portion of the eyewear illustrated in FIG. 4 showing the relationship between an engagement member, the front frame and the lens assembly in a state where the temple of the eyewear is partially open.

FIG. 6 is an enlarged bottom view of the connection portion illustrated in FIGS. 4 and 5 showing the relationship between the engagement member, the front frame and the lens assembly in the state where the temple of the eyewear is fully open.

FIG. 7 is a front perspective view of an eyewear (sunglasses) according to another embodiment of the present disclosure.

### DETAILED DESCRIPTION OF EMBODIMENTS

Selected embodiments will now be explained with reference to the drawings. It will be apparent to those skilled in the eyewear field from this disclosure that the following descriptions of the embodiments are provided for illustration only and not for the purpose of limiting the invention as defined by the appended claims and their equivalents.

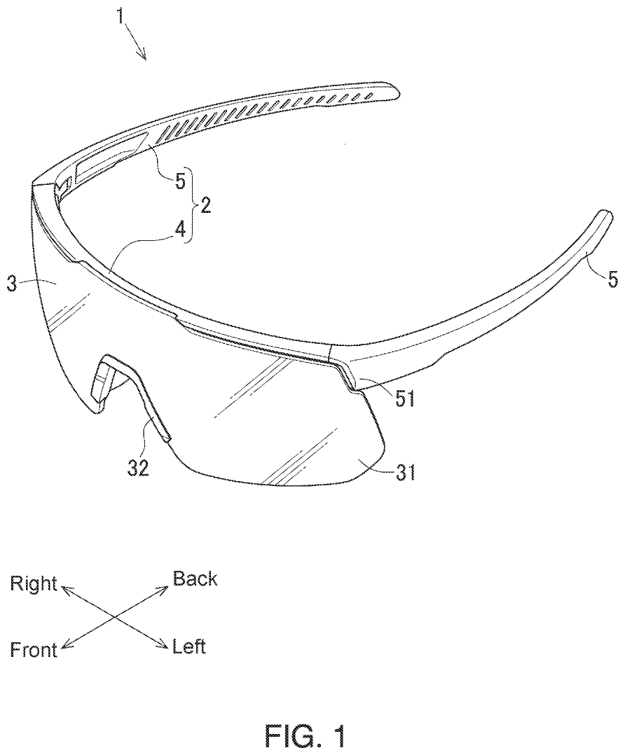

Referring initially to FIG. 1, a pair of sunglasses 1 is illustrated as an eyewear according to one embodiment of the present disclosure. The directional expressions in relation to front and back and up and down hereinbelow correspond to the directions of the eyewear in a positional state shown in FIG. 1. The far side relative to the user's face is referred to the front side and the close side relative to the user's face is referred to the back side. The side corresponding to the user's right eye is referred to the right side, and the side corresponding to the user's left eye is referred to the left side.

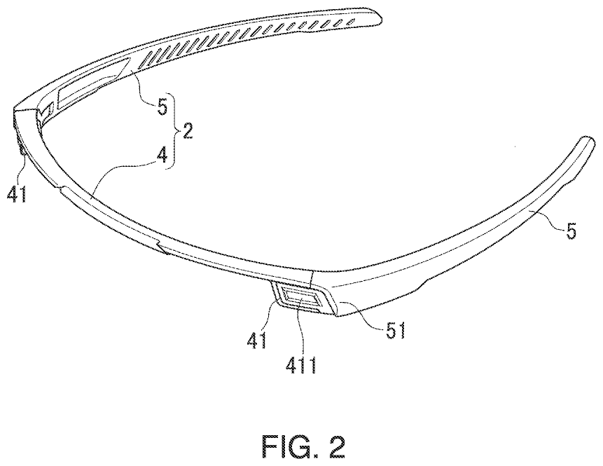

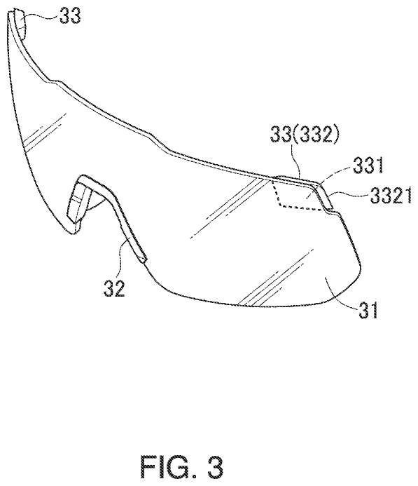

As shown in FIG. 1, the sunglasses 1 of this embodiment include a frame part 2, and a lens assembly 3 formed separately from the frame part 2. As shown in FIG. 2, the frame part 2 includes a front frame 4 and a pair of temples 5. The front frame 4 is positioned on the front side of the user's face when worn. The temples 5 are continuous with the right and left ends of the front frame 4, and are configured to be hung on the user's ear in worn. The front frame 4 has a pair of connecting parts 41. The connecting parts 41 are respectively connected to a pair of connected parts 33 (see FIG. 3) disposed on the lens assembly 3. In other words, the connected parts 33 are provided to the lens assembly 3 and the connecting parts 41 are provided to the front frame 4. Thereby, the frame part 2 and the lens assembly 3 are integrated together as shown in FIG. 1. The connection in this embodiment is made by a magnetic force. Therefore, the connecting parts 41 of this embodiment are configured to have magnetic metal pieces as magnetic substances 411 embedded in the front frame 4.

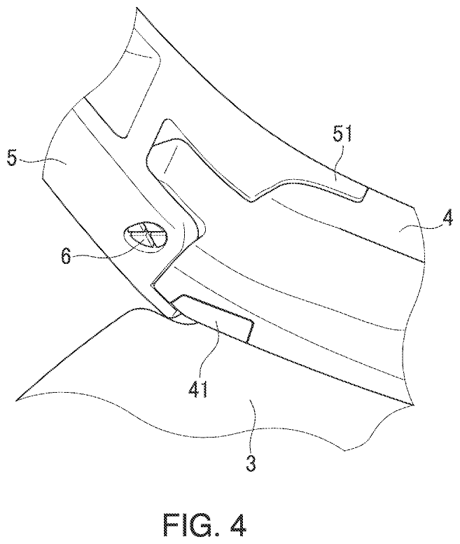

Each of the temples 5 is connected to the front frame 4 by a hinge 6 (see FIG. 4, etc.) to be pivotally movable relative to the front frame 4. Thereby, the temples 5 are configured to be pivotally movable relative to the front frame 4. This pivotal movement enables connection between each of the temples 5 and the front frame 4 to be openable and closable relative to each other. FIG. 1 shows the fully open state. The right and left temples 5 are each pivotally moved around the hinge 6 to overlap with each other so as to come into a closed state (not shown). Each of the temples 5 has an engagement member 51 that is configured to suppress falling of the lens assembly 3 from the frame part 2. The description on the engagement member 51 will be given later.

The lens assembly 3 is attachable and detachable relative to the front frame 4, and is located on the front side of the front frame 4 in worn state, as shown in FIG. 1. Herein, the expressions “attachable” and “detachable” is meant to be realized by a connection where the user can attach and detach one part from another part by hand such as a magnetic force of this embodiment or the like. Therefore, a connection that is “attachable” and “detachable” will be referred to as a configuration where the user can attach and detach by hand. On the other hand, a configuration where the attachment and detachment cannot be realized unless a screw driver or other tools are used will be excluded from the meaning of the expression “attachable and detachable”.

As shown in FIG. 3, the lens assembly 3 has a light transmission part 31, a nose pad 32, and the connected parts 33. The light transmission part 31 is for example a lens through which light passes in a thickness direction of the light transmission part 31. The nose pad 32 is connected to the light transmission part 31, and is configured to contact a wearer's nose. The connected parts 33 are configured to be connected to the connecting parts 41 of the front frame 4 when the lens assembly 3 is attached to the front frame 4. Each of the connected parts 33 has a magnet (permanent magnet) 331, and a frame-shaped magnet retaining part 332 having the magnet 331 embedded therein. In this embodiment, the magnet 331 and the magnet retaining part 332 are formed to be integral with each other. The magnet retaining parts 332 are respectively secured to the back surface on the right and left sides of the light transmission part 31 by bonding or the like. The combination of the magnets 331 of the lens assembly 3 and the magnetic substances 411 of the frame part 2 causes a magnetic force enabling connection between the lens assembly 3 and the front frame 4, so that when the lens assembly 3 is attached, the user requires to take no other operations than positioning of the lens assembly 3 relative to the front frame 4. Thus, easy attachment and detachment between the lens assembly 3 and the front frame 4 by the user's hand is possible. The lens assembly 3 of this embodiment has a right eye part and a left eye part formed to be integral with each other. Therefore, it is possible to allow the lens assembly 3 to be easily attached to and detached from the front frame 4 in integral manner.

It can be configured such that each of the magnets 331 is disposed at any one of each of the connecting parts 41 and each corresponding one of the connected parts 33 (the connected part 33 in this embodiment), and each of the magnetic substances 411 to be attracted by the magnet 331 is disposed at the remaining one of the connecting part 41 and the connected part 33 (the connecting part 41 in this embodiment). In replacement of the combination of the magnet 331 and the magnetic substance 411, it can be configured such that a pair of magnets which are opposed to each other while having an opposite polarity relationship are used.

In the sunglasses 1 of this embodiment, the light transmission part 31 is formed of a colored light passing material (specifically a resin plate). The light transmission part 31 can be prescription glasses (e.g., glasses) or non-prescription glasses (e.g., sunglasses). The light transmission part 31 can be transparent. Further, the light transmission part 31 can be configured to have at least one slit or hole passing through an opaque plate in the thickness direction. The light transmission part 31 can be a mesh-like form.

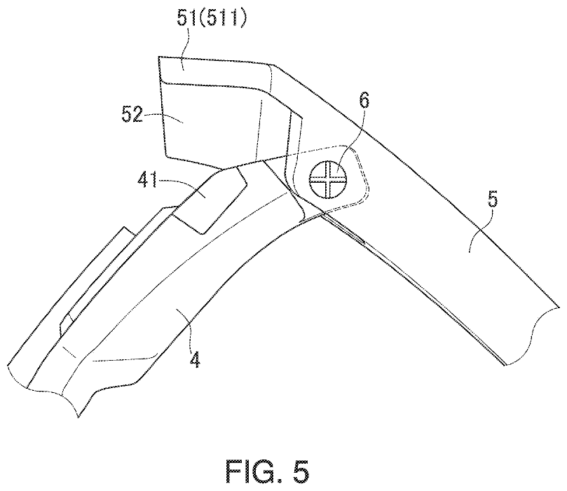

Each one of the engagement members 51 is provided to each corresponding one of the temples 5. In other words, the engagement members 51 are disposed on the temples 5, respectively. Specifically, the engagement member 51 is integrally formed with one end on the front frame 4 side of the temple 5. With this configuration, it is possible to easily form the engagement member 51 that moves close toward and away from the front frame 4. Specifically, as shown in FIG. 5, each of the engagement members 51 has a claw part 511 formed of the one end of the temple 5 with its width reduced. This claw part 511 has a shape of the temple 5 with its crossing or lateral dimension reduced, and a plate-shaped part formed located close to any one of the right and left sides at one end of the temple 5. In this embodiment, as shown in FIG. 5, an overhanging upper surface part 52 is formed in addition to the claw part 51 at one end of the temple 5. This upper surface part 52 is formed integrally with the one end of each of the temples 5, but the upper surface part 52 can be eliminated.

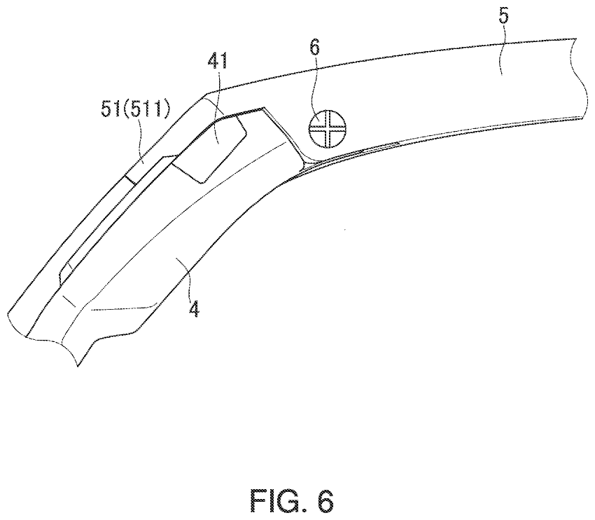

The engagement member 51 (specifically, the claw part 511) moves toward and away from the front frame 4 in association of the opening and closing motions due to the pivotal motion around the hinge 6 of the temple 5. When the temple 5 moves close to the front frame 4, the engagement member 51 is engageable with the lens assembly 3 located on the front side of the front frame 4. More specifically, when the temple 5 is in open state (specifically in the fully open state as shown in FIG. 1 and FIG. 6), the engagement member 51 engages with the lens assembly 3. The engagement member 51 engages with the lens assembly 3 along a corresponding side end edge 3321 (see FIG. 3) that is a part of the magnet retaining part 332 of the lens assembly 3. The engagement member 51 engages with the lens assembly 3 to cover the magnet retaining part 332 from the front side. With this configuration of the engagement member 51, the engagement member 51 is allowed to engage with the lens assembly 3 by the opening of the temple 5 so that it is possible to securely suppress the lens assembly 3 from falling from the frame part 2 (front frame 4) of the lens assembly 3.

When the lens assembly 3 is attached to the front frame 4, and the engagement member 51 of each corresponding one of the temples 5 engages with the lens assembly 3, the connected part 33 and each corresponding one of the engagement members 51 of the lens assembly 3 are held overlapping at least partly with each other when seen in the direction toward the front side of the lens assembly 3 (front and back direction). Thereby, even if the lens assembly 3 is about to fall from the front frame 4 toward the front side, the lens assembly 3 cannot move to the front side because the engagement members 51 press the lens assembly 3 from the front side. Thus, the engagement members 51 can assist the connecting state between the connecting parts 41 and the connected parts 33.

The engagement members 51 can press the connected parts 33 to the front frame 4 (connecting parts 41) in the state where they engage with the lens assembly 3. In this embodiment, as described above, since the engagement member 51 and each corresponding one of the connected parts 33 at least partly overlap with each other when seen in the direction toward the front side of the lens assembly 3 (front and back direction), the pressing of the connected parts 33 by the engagement members 51 can be easily made. Since the connected parts 33 are pressed onto the front frame 4 in addition to the engagement of the engagement members 51 with the lens assembly 3, the engagement is strengthened and hence it is possible to more securely suppress falling of the lens assembly 3. It is to be noted that as long as the connected parts 33 are pressed, the light transmission part 31 needs not to be pressed. Rather, in order to avoid distortion of the light transmission part 31, it is preferable that the light transmission part 31 be not pressed by the engagement members 51.

According to this embodiment, the engagement members 51 of the temples 5 engage with the lens assembly 3, in addition to the connection of the connecting parts 41 of the front frame 4 with the connected parts 33 of the lens assembly 3. Therefore, since the lens assembly 3 which is connected to the front frame 4 by the magnetic force is allowed to engage with the front frame 4 by the engagement members 51, it is possible to produce an advantage of making it possible for the lens assembly 3 to hardly fall from the front frame 4.

The eyewear (e.g., the sunglasses 1) of the present disclosure is described above by way of one example of an embodiment, but the eyewear is not limited to the aforementioned embodiment. Thus, the eyewear of the present invention can be subjected to various modifications within the intended scope of the present invention.

For example, the connecting method is not limited to the magnets (permanent magnets) 331 and the magnetic substances 411 for the connecting parts 41 and the connected parts 33 according to the aforementioned combination. However, the connecting method is not limited thereto. For example, the connection can be achieved by fitting engagement such as the engagement between a cutout, a hole or a recess and a protrusion, or connection utilizing a hook and loop fastener, or connection utilizing adhesive members.

In the above embodiment, each of the connected parts 33 of the lens assembly 3 has the magnet (permanent magnet) 331, and the frame-shaped magnet retaining part 332 with the magnet 331 embedded therein. However, for example, as a configuration without the magnet retaining part 332, it can be configured such that the magnet 331 is directly fixed to the light transmission part 31.

In the above embodiment, each of the engagement members 51 is configured to engage with the corresponding side end edge 3321 that is a part of the magnet retaining part 332 of the lens assembly 3. However, the eyewear (e.g., the sunglasses 1) of the present disclosure is not limited thereto, and the engagement member 51 can be configured to engage with another part of the lens assembly 3 (including the light transmission part 31).

Further, in the above embodiment, the connecting parts 41 (magnetic substances 411) are provided to both the right and left sides of the front frame 4, and the engagement members 51 are provided tot the ends on the right and left of a pair of the temples 5. However, the eyewear (e.g., the sunglasses 1) of the present disclosure is not limited thereto, and different configurations can be respectively applied to the right side and the left side. Specifically, it can be configured such that the connecting part 41 (magnetic substance 411) is disposed only on one of the right and left sides of the front frame 4, and the engagement member 51 is disposed only on the remaining side of the pair of the temples 5. In this configuration, the remaining right or left side of the front frame 4 can be configured such that the lens assembly 3 is held not by the magnetic force but by the engagement such as projection recess fitting. Further, as in the above embodiment, while the connecting parts 41 (magnetic substances 411) are disposed on both the right and left sides of the front frame 4, the engagement member 51 can be disposed only on one of the right and left sides of the pair of the temples 5.

Each of the engagement members 51 can be a separate member to be attached to a body of each corresponding one of the temples 5 rather than an integral part of the temple 5. This configuration also can meet the requirements as long as each of the engagement members 51 can move toward and away from the front frame 4 in association with the opening and closing motions of the temples 5.

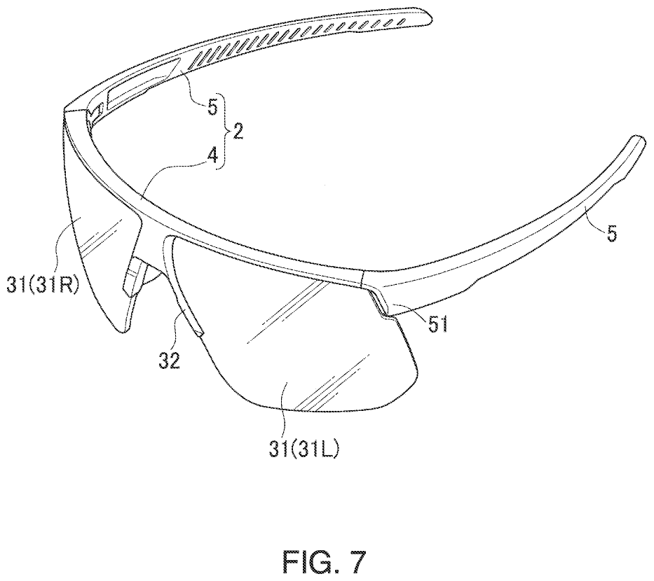

As shown in FIG. 7, the lens assembly 3 can be configured such that the light transmission part 31 has a left eye part 31L and a right eye part 31R in separate form. In this case, for example, the connecting parts 41, and the engagement members 51 on the right and left sides of the front frame 4 and the pair of the temples 5 respective have the same functions as those of the aforesaid embodiment, and it can be configured such that the front frame 4 and the lens assembly 3 engage with each other such as by the protrusion recess fitting around the nose pad so as to hold the lens assembly 3. Contrarily, it can be configured such that the connection is made around the nose pad 32 by the magnetic force so as to achieve the engagement by the engagement members 51 on the sides of the temples 5.

The eyewear of the disclosure invention is described above by way of the above embodiment, but is not limited to the aforementioned embodiment. Thus, the present invention can be subjected to various modifications within the intended scope of the present invention. Further, the operation and effect of the present invention are not limited to the above embodiments. That is, the embodiments disclosed herein should be considered to be illustrative in all respects and not restrictive. The scope of the present invention is indicated by the appended claims, not by the above description. It is also contemplated that the scope of the present invention includes all modifications within the meaning and scope of equivalence to the claims.

What is claimed is:

1. An eyewear comprising:
a front frame having a pair of connecting parts;
a pair of temples connected to the front frame to be openable and closeable relative to the front frame;
a lens assembly having a light transmission part for transmitting light, and a pair of connected parts to be respectively connected to the connecting parts at a time of attachment to the front frame, so that the lens assembly can be detachably attached to the front frame; and
a pair of engagement members respectively provided to the temples, and configured to move toward and away from the front frame in association with opening and closing motions of the temples, so that the engagement members are engageable with the lens assembly.

2. The eyewear according to claim 1, wherein
each of the engagement members is provided to a front frame side end of each corresponding one of the temples.

3. The eyewear according to claim 1, wherein
each of the engagement members is engageable with the lens assembly when each corresponding one of the temples is in open state.

4. The eyewear according to claim 1, wherein
each of the connected parts and each corresponding one of the engagement members at least partly overlap with each other when the lens assembly is seen in the direction toward the front side of the lens assembly, in the state where the lens assembly is attached to the front frame and each of the engagement members engages with the lens assembly.

5. The eyewear according to claim 1, wherein
the lens assembly is located on the front side of the front frame, and each of the engagement members presses each corresponding one of the connected parts toward the front frame in the state where the engagement members engage with the lens assembly.

6. The eyewear according to claim 1, wherein
a magnet is provided to any one of each one of the connecting parts and each corresponding one of the connected parts, while a magnetic substance to which the magnet is attracted is provided to disposed at the remaining one of the connecting part and the connected part.

7. The eyewear according to claim 1, wherein
the lens assembly has a right eye part and a left eye part integrally formed with each other.

8. The eyewear according to claim 2, wherein
each of the engagement members is engageable with the lens assembly when each corresponding one of the temples is in open state.

9. The eyewear according to claim 2, wherein
each of the connected parts and each corresponding one of the engagement members at least partly overlap with each other when the lens assembly is seen in the direction toward the front side of the lens assembly, in the state where the lens assembly is attached to the front frame and each of the engagement members engages with the lens assembly.

10. The eyewear according to claim 2, wherein
the lens assembly is located on the front side of the front frame, and each of the engagement members presses each corresponding one of the connected parts toward the front frame in the state where the engagement members engage with the lens assembly.

11. The eyewear according to claim 2, wherein
a magnet is provided to any one of each one of the connecting parts and each corresponding one of the connected parts, while a magnetic substance to which the magnet is attracted is provided to the remaining one of the connecting part and the connected part.

12. The eyewear according to claim 3, wherein
each of the connected parts and each corresponding one of the engagement members at least partly overlap with each other when the lens assembly is seen in the direction toward the front side of the lens assembly, in the state where the lens assembly is attached to the front frame and each of the engagement members engages with the lens assembly.

13. The eyewear according to claim 3, wherein
the lens assembly is located on the front side of the front frame, and each of the engagement members presses each corresponding one of the connected parts toward the front frame in the state where the engagement members engage with the lens assembly.

14. The eyewear according to claim 3, wherein
a magnet is provided to any one of each one of the connecting parts and each corresponding one of the connected parts, while a magnetic substance to which the magnet is attracted is provided to the remaining one of the connecting part and the connected part.

15. The eyewear according to claim 4, wherein
the lens assembly is located on the front side of the front frame, and each of the engagement members presses each corresponding one of the connected parts toward the front frame in the state where the engagement members engage with the lens assembly.

16. The eyewear according to claim 4, wherein
a magnet is provided to any one of each one of the connecting parts and each corresponding one of the connected parts, while a magnetic substance to which the magnet is attracted is provided to the remaining one of the connecting part and the connected part.
